(19) United States
(12) Patent Application Publication
(10) Pub. No.: US 2005/0264797 A1
(43) Pub. Date: Dec. 1, 2005

(54) Method and apparatus for detecting defects

(76) Inventors: Hiroyuki Nakano, Yokohama (JP); Minori Noguchi, Mitsukaido (JP); Yoshimasa Ohshima, Yokohama (JP); Sachio Uto, Yokohama (JP); Akira Hamamatsu, Yokohama (JP); Hisafumi Iwata, Hayama (JP); Tetsuya Watanabe, Honjyo (JP); Takahiro Jingu, Takasaki (JP); Hideki Fukushima, Higashichichibu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/136,664

(22) Filed: May 25, 2005

(30) Foreign Application Priority Data
May 26, 2004 (JP) 2004-156142

(51) Int. Cl. G01N 21/88

(52) U.S. Cl. 356/237.2

(57) ABSTRACT

The present invention relates to a defect detection apparatus and method by which foreign particles and circuit pattern defects can be detected in distinction from the edge roughness of wiring on the substrate. The defect detection apparatus comprises an irradiation optical system includes: a beam expander; an optical member group formed by stacking multiple plate-like optical members each having a different optical path length at least in a beam-converging direction in order to admit the laser beam with the beam diameter extended by the beam expander and emit multiple slit-like beams each spatially reduced in coherence in the beam-converging direction; and beam-converging optical system by which the multiple slit-like beams each emitted from the optical member group is converged into a slit-like beam in the beam-converging direction and the slit-like beam is irradiated from an oblique direction onto the surface of the subject.

### BACKGROUND OF THE INVENTION

The present invention relates to a method and apparatus for detecting any foreign particles or circuit pattern defects occurring during the manufacture of LSI and liquid-crystal substrates.

Conventional technologies for detecting, in discrimination from the circuit patterns formed on semiconductor wafers, the foreign particles sticking to or defects present on the circuit patterns, are disclosed in Japanese Patent Laid-open Nos. 1-117024 (corresponding to U.S. Pat. No. 6,411,377), 8-210989, 2000-105203 (corresponding to U.S. Pat. No. 5,046,847), 2001-194323 (corresponding to U.S. Pat. No. 6,621,571), and 2003-177102 (corresponding to U.S. application Ser. No. 10/650,756).

Japanese Patent Laid-open No. 1-117024 describes the technology intended for smoothing or averaging the intensity of the light reflected from the thin films formed on a substrate. In this case, first, laser light that has been emitted from a semiconductor oscillator is split into the plurality of beams made mutually incoherent by differentiating each in optical path length by use of a multistage mirror. Next, the substrate with a thin film formed thereon so as to permit the beams to effectively pass through at the same time at different angles of incidence is illuminated by converging the beams of light via a parabolic mirror. After that, the beams of illumination light scattered from the very small foreign particles or microdefects existing on the substrate are further converged by a converging lens and detected by a detector.

Also, Japanese Patent Laid-open No. 8-210989 describes a foreign particle detection apparatus by which the circuit pattern formed on a wafer is illuminated from the direction of 45 degrees with respect the main lines on the circuit pattern so that the zeroth-order diffracted light generated from the main lines may not be input to the aperture in an objective lens, and scattered light generated from other lines is intercepted by a spatial filter.

Additionally, Japanese Patent Laid-open No. 2000-105203 describes a defect detection apparatus that includes: irradiation optics which, after changing into a slit-like beam the laser beam emitted from a laser light source, irradiates the object to be detected with the slit-like beam from an oblique direction; detection optics that uses an image sensor, such as a TDI sensor (Time Delay Integration sensor), to receive the above slit-like beam reflected/scattered from the object to be detected, and then change the beam into signal form; and an imaae processing unit that extracts foreign particles or pattern defects on the basis of the signal detected by the image sensor of the detection optics.

It is further described in Japanese Patent Laid-open No. 2001-194323 that the detection optics includes a spatial filter and that the irradiation optics also conducts white-light illumination from an oblique direction.

Furthermore, Japanese Patent Laid-Open Nos. 2001-194323 and 2003-177102 describe the pattern inspection apparatus that includes the objective lens for detecting an image of a sample, laser illumination means for conducting illumination by converging light on the pupil position of the objective lens, means for reducing the coherence of laser illumination, means for detecting light reflections from the circuit pattern on the sample by using the storage type of TDI sensor provided above the circuit pattern, and an image processing unit for processing detection signals.

The kinds of patterns formed on workpieces (e.g., semiconductor wafers) during the manufacture of LSI and liquid-crystal substrates include such iterative patterns (repeated patterns) as represented by the patterns formed in DRAM (Dynamic Random Access Memory) sections, and such random patterns (non-iterative patterns) as represented by those formed in logic circuits. If foreign particles stick to or pattern defects occur on the surfaces of these workpieces during the manufacture of LSI and liquid-crystal substrates, this will cause pattern defects in workmanship, such as improper electrical wiring insulation or short-circuiting. In these cases, with the increased tendency towards finer structuring of circuit patterns, edge roughness of the patterns formed on the workpieces has becoming difficult to discriminate from fine-structured foreign particles or microdefects. Accordingly, the edge roughness that is not a pattern defect is recognized as a defect, in other words, false defect information occurs, and to suppress the occurrence of the false defect information, the need may arise to reduce detection sensitivity and conduct inspections with low detection sensitivity.

### SUMMARY OF THE INVENTION

The present invention is intended to provide a defect detection method and apparatus that uses a high-coherence laser as a light source and is adapted to improve defect detection sensitivity with a simple configuration by reducing the coherence of laser light, conducting focused slit-like light beam illumination from an oblique direction, smoothing the noise-scattered light generated from nondefective edge roughness, and making obvious the light scattered/diffracted by the defects that include foreign particles.

According to an aspect of the present invention, there is provided a defect detection apparatus, and a method therefor, that includes: irradiation optics having a laser light source and an irradiation system which reduces the coherent laser light emitted from the laser light source, converges the laser light into a slit-like beam, and directs the split-like beam from an oblique direction onto the surface of a substrate to be subjected to defect detection; detection optical system that detects the scattered light generated from the substrate which has been irradiated therewith by the irradiation system of the irradiation optical system; a linear sensor that receives the light detected by the detection optical system, and outputs corresponding image signals; a comparison processing unit that compares with the image signals obtained from the same region of chips or cells and then output from the linear sensor, and identifies the defects or defect candidates, including foreign particles, that exist on the substrate being subjected to defect detection.

The irradiation system of the foregoing irradiation optical system is further constructed so as to include: an optical member group formed by stacking a plurality of plate-like optical members (light-transmitting media) which incident the coherent laser beams emitted from the foregoing laser light source, and emit a plurality of slit-like beams each of which has been spatially reduced in coherence at least in a beam-converging direction, the plurality of plate-like optical members being different from one another in optical path length at least in the beam-converging direction; and beam-converging optical system which converges the plurality of slit-like beams each emitted with spatially reduced coherence from the foregoing optical member group, into a slit-like beam in the beam-converging direction and then directs the slit-like beam from the oblique direction onto the surface of the substrate to be subjected to defect detection.

The present invention also has a beam expander in the above irradiation system. The beam expander is adapted to extend a beam diameter of the coherent laser light emitted from the foregoing laser light source, so as to incident into the optical member group the laser beam whose beam diameter has been extended by the above beam expander.

In addition, the present invention is adapted to emit UV or DUV laser light from the foregoing laser light source.

Furthermore, the present invention is constructed so that in the foregoing beam-converging optical system, multi-angle irradiation of the slit-like beam is conducted in the beam-converging direction.

Moreover, the present invention is constructed in order for the optical members in the foregoing optical member group to differ from one another in optical path length in a longitudinal direction of the slit-like beam so that mutual spatial incoherence between the optical members is also achieved in the longitudinal direction.

Besides, the present invention has a spatial filter in the foregoing detection optical system, the spatial filter shielding reflection/diffraction interference patterns generating from iterative patterns present on the substrate to be subjected to defect detection.

Additionally, the detection optical system of the present invention has a Fourier transform lens group constructed into bilateral telecentric form.

Furthermore, the foregoing linear sensor in the present invention is formed as a TDI sensor.

According to the present invention, the advantageous effect is yielded that foreign particle/pattern defect detection sensitivity can be improved by using a high-coherence laser as a light source, reducing coherence with a simple configuration, conducting focused slit-like light beam illumination from an oblique direction, smoothing the noise-scattered light generated from nondefective edge roughness, and making obvious the light scattered/diffracted by foreign particles and Pattern defects.

These and other objects, features, and advantages of the invention will be apparent from the following more particular description of preferred embodiments of the invention, as illustrated in the accompanying drawings.

### BRIEF DESCRIPTION OF THE DRAWINGS

FIG. 1 is a schematic configuration diagram showing an embodiment of a defect detection apparatus according to the present invention;

FIG. 2a is a plan view showing a first example of irradiation optical system which is a first embodiment of a defect detection apparatus according to the present invention, and FIG. 2b is a front view of the first example;

FIG. 3 is a perspective view of the plate-like lens group shown in FIGS. 2a, 2b;

FIG. 4a is a plan view showing a second example of the irradiation optical system which is the first embodiment of a defect detection apparatus according to the present invention, and FIG. 4b is a front view of the second example;

FIG. 5 is a perspective view of the plate-like lens group shown in FIGS. 4a, 4b;

FIG. 6a is a plan view of the iterative patterns irradiated with a slit-like beam of light, FIG. 6b is a diagram of the relationship between an objective lens and iterative patterns (repeated patterns) LS, explaining a case in which the slit-like beam of light is emitted so that its longitudinal direction is substantially perpendicular to a direction of the iterative patterns LS, and FIG. 6c is a view taken from a perpendicular direction with respect to FIG. 6b;

FIG. 7 is a diagram showing reflected/diffracted light patterns of the iterative patterns generated on a Fourier transform plane by using the slit-like beam irradiation method shown in FIGS. 6a-6c;

FIG. 8 is a diagram showing in state of shielding the reflected/diffracted light patterns of FIG. 7 by a spatial filter;

FIG. 9 is a front view showing the single-mode fiber bundle used in the first example of the irradiation optical system which is the second embodiment of a defect detection apparatus according to the present invention;

FIG. 10 is a front view showing the optical system provided at the entry side of light with respect to the single-mode fiber bundle used in the first example of the irradiation optical system which is the second embodiment of a defect detection apparatus according to the present invention;

FIG. 11 is a perspective view of the one-dimensional fly's-eye lens array (converging lens group) shown in FIG. 10;

FIG. 12 is a perspective view of the two-dimensional fly's-eye lens array (converging lens group) shown in FIG. 10;

FIG. 13 is a diagram showing a one-dimensionally arrayed light-incident end face of the single-mode fiber bundle shown in FIG. 10;

FIG. 14 is a diagram showing an example of a two-dimensionally arrayed incident end face of the single-mode fiber bundle shown in FIG. 10;

FIG. 15 is a diagram showing another example of a two-dimensionally arrayed incident end face of the single-mode fiber bundle shown in FIG. 10;

FIG. 16 is a sectional view that shows a stacking type of bundling method for the single-mode fiber bundle shown in FIG. 10;

FIG. 17 is a sectional view that shows a hexagonal honeycomb-structured stacking format as another bundling method for the single-mode fiber bundle shown in FIG. 10;

FIG. 18a is a plan view showing the optical system provided at the exit side of light with respect to the single-mode fiber bundle used in the first example of the irradiation optical system which is the second embodiment of a defect detection apparatus according to the present invention, and FIG. 18b is a front view of the above optical system;

FIG. 19 is a diagram showing a slit-like beam with which the surface of an object to be subjected to defect detection is to be irradiated in the first embodiment of a defect detection apparatus according to the present invention;

FIG. 20 is a perspective view showing a state in which a different exit angle is assigned to an exit end of each single-mode fiber of the first example in the single-mode fiber bundle for the irradiation optical system which is the second embodiment of a defect detection apparatus according to the present invention;

FIG. 21a is a plan view showing the optics provided at the light-exit side of a first example in another type of multi-mode fiber bundle for the irradiation optical system which is the second embodiment of a defect detection apparatus according to the present invention, and FIG. 21b is a front view of the above optical system;

FIG. 22 is a perspective view showing a state in which an aperture at an exit end of yet another type of multi-mode fiber bundle in the second example of the irradiation optical system which is the second embodiment of a defect detection apparatus according to the present invention is reduced in diameter;

FIG. 23a is a plan view showing the multi-mode fibers of FIG. 22 in the state where the aperture is reduced in diameter, and FIG. 23b is a front view of the multi-mode fibers;

FIG. 24 is a diagram showing the exit end of the multi-mode fibers shown in FIG. 22;

FIG. 25a is a plan view showing the optical system whose exit side uses the multi-mode fiber bundle having an exit end reduced in diameter of the aperture in the second example of the irradiation optical system which is the second embodiment of a defect detection apparatus according to the present invention, and FIG. 25b is a front view of the above optical system;

FIG. 26 is an explanatory diagram of signal detection based on the noise-scattered light generating from nondefective rough edges of a hyperfine circuit pattern when the circuit pattern is irradiated with laser light;

FIG. 27a is a plan view showing the optical system provided at the light-exit side of the second example in single-mode fibers of the irradiation optical system which is the second embodiment of a defect detection apparatus according to the present invention, and FIG. 27b is a front view of the above optical system;

FIG. 28a is a plan view showing the optical system provided at the light-exit side of a third example in single-mode fibers of the irradiation optical system which is the second embodiment of a defect detection apparatus according to the present invention, and FIG. 28b is a front view of the above optical system.

### DESCRIPTION OF THE PREFERRED EMBODIMENTS

Embodiments of a defect detection method and apparatus according to the present invention will be described using the accompanying drawings. In the following description, detection of foreign particles (foreign matters) on a semiconductor wafer is taken as an example.

### First Embodiment

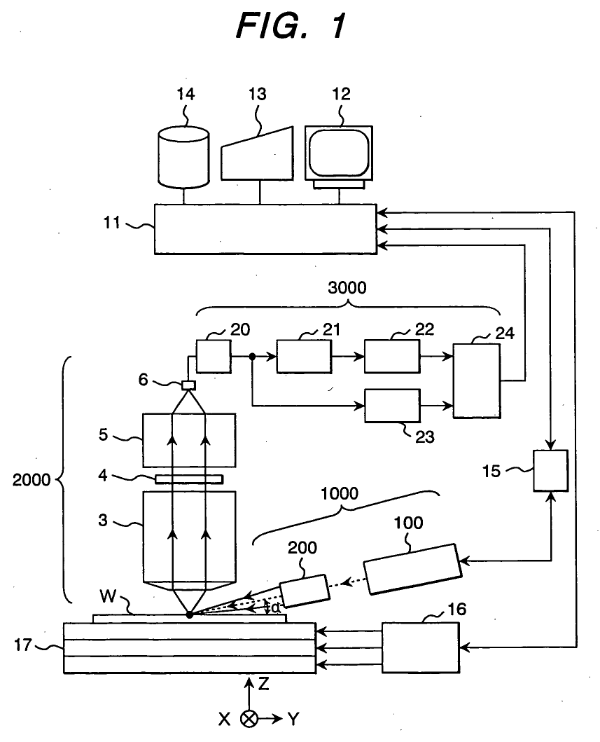

A first embodiment of the present invention will be described with reference to FIGS. 1 to 8.

First, an example of a defect detection apparatus for detecting foreign particles and pattern defects on a semiconductor wafer is shown in FIG. 1. The defect detection apparatus is constructed so as to include: an irradiation optical system 1000, one feature of the present invention; a detection optical system 2000; an image processing unit 3000; a light source driver 15 that drives a laser light source 100; a main controller unit 11 that connects a display 12, an arithmetic device 13, a storage device 14, and an input/output section (network included) not shown, and controls the entire apparatus; an X-Y-Z stage 17 for resting thereon, for example, a semiconductor wafer W as an object to be subjected to defect detection, and moving the object W in X-, Y-, and Z-directions; and an X-Y-Z stage driver that conducts driving control of the X-Y-Z stage 17, based on commands from the main control unit 11.

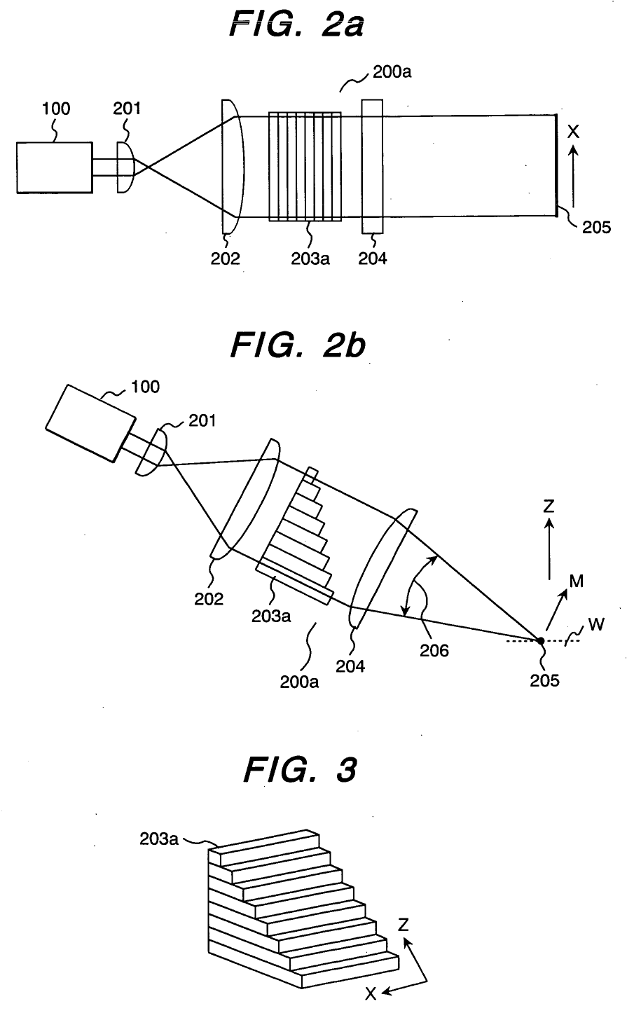

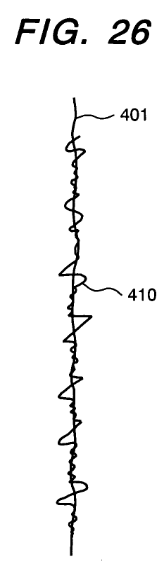

The irradiation optical system 1000, one feature of the present invention, uses the laser light source 100 for emitting the ultraviolet rays (hereinafter, referred to as the UV laser light) or deep ultraviolet rays (hereinafter, referred to as the DUV laser light) that allow a shorter wavelength to be easily obtained. The UV laser light in the present invention refers to laser light whose approximate wavelength ranges from 100 to 400 nm, and the DUV laser light refers to laser light whose approximate wavelength ranges from 100 nm to 314 nm. The laser light emitted from the laser light source 100 typically has coherence. For this reason, when a hyperfine circuit pattern with a pattern width of 80 nm or less on the object W is irradiated with the laser light, speckle noise occurs and as shown in FIG. 26, noise-scattered light generates from the presence of a nondefective rough edge (a nondefective edge roughness) 401. Therefore, for example, if chip comparisons indicate a mismatch, i.e., if a foreign particle or a pattern defect is detected, a signal 410 due to the noise-scattered light cannot be erased and the nondefective rough edge 401 is incorrectly detected as a mismatch. The irradiation optical system 1000, therefore, includes the laser light source 100 and an irradiation system (irradiation section) 200. The irradiation system 200 reduces the coherence of the coherent laser beams emitted from the laser light source 100, then converges the laser beams into the slit-like beam matching a light-receiving surface of a detector 6, and irradiates the slit-like beam from an oblique direction (a direction in which regular light reflections from the object W do not enter a pupil of an objective lens 3 at a horizontal angle “a” of 300 or less) onto the hyperfine circuit pattern of the object W. In this way, the slit-like beam is created because the amount of light per unit area is to be increased according to a particular shape of the light-receiving surface of the detector 6. Also, as shown in FIG. 2b, convergence into slit-like beam (linear beam) 205 is intended to obtain a smoothed signal by letting a plurality of mutually coherence-reduced beams enter edge roughness 401 of the hyperfine circuit pattern from different directions, and then further reducing the coherence of the beams.

The detection optical system 2000 includes: the objective lens 3 for converging the light reflected/scattered (reflected/diffracted) by the object W; a spatial filter 4 for shielding the diffracted light patterns (the interference patterns) generating from the edges of iterative (repeated) circuit patterns present on the surface of the object W; a tube lens 5 that is an image-forming lens; and the detector (linear sensor) 6 such as a TDI sensor, anti-blooming TDI sensor, CCD linear image sensor, or photomultiplier array. In this way, the detection optical system 2000 constitutes bi-telecentric Fourier transform optical system and is adapted also to allow optical processing of the light scattered by the object W, such as modification, adjustment, and others of optical characteristics by spatial filtering.

The image processing unit 3000 includes: an A/D converter 20 for obtaining detected image data by A/D-converting the image signals obtained from the detector 6; a delay circuit 21 for delaying the detected image data obtained from iterative chips or memory cells, according to a particular pitch of the iterative chips or memory cells, and obtaining reference image data; image memories 22 and 23 for storage of the reference image data and the detected image data, respectively; and a comparison and arithmetic processing unit (comparison processing unit) 24 that compares the reference image with the detected image data, extracts differential image data, compares the differential image data (mismatch values) with judgment thresholds, identifies foreign particles or pattern defects, and outputs position coordinates, characteristic values (such as an area and a size/dimensions), defect images, and other factors of the foreign particles or defects, to the main controller 11.

For internal logic sections of the chips, in particular, the comparison and arithmetic processing unit 24 compares the reference image data and detected image data obtained for each chip by the delay circuit 21. In addition, if differential image data (mismatch value) between the above two types of data is found to be in excess of judgment thresholds, the comparison and arithmetic processing unit 24 judges that foreign particles or pattern defects are present.

Examples of the irradiation optical system 1000 that is one feature of the present invention will be next described using FIGS. 2a, 2b, to 16.

First, a first example of the irradiation optical system 1000 is described using FIGS. 2a, 2b, and 3. The first example of the irradiation optical system 1000 includes a laser light source 100 for emitting UV laser light or DUV laser light, and an irradiation system (irradiation section) 200a. The irradiation system 200a includes: a beam expander 201, a collimator lens 202, an optical member group 203a, and a cylindrical lens (converging optical system) 204. The beam expander 201 extends a beam diameter of the UV laser light or DUV laser light emitted from the laser light source 100. The collimator lens 202 converts expanded beams into substantially parallel beams. The optical member group 203a is formed by stacking the large number of plate-like optical members (light-transmitting media or glass materials) that are made of, for example, synthetic quartz, BK7, or the like, and, as shown in FIG. 3, have optical paths whose widths in an X-direction are greater than a width of parallel beams, and whose lengths in an oblique direction (a direction of inclination angle “α”) and an M-direction (direction of convergence into a slit-like beam 205) that is perpendicular to the X-direction differ from one another. The cylindrical lens (converging optical system) 204 converges, in the M-direction, the plurality of slit-like beams with reduced spatial coherence (mutual coherence) in the M-direction of their emission from the optical member group 203a, by changing an irradiating direction of the beams in a wide range as denoted by arrow 206, and irradiates edge roughness (rough edges) 401 of a hyperfine circuit pattern with the slit-like beam 205.

A mirror for changing a traveling direction of the beams may be disposed between the cylindrical lens (converging optical system) 204 and the surface of the object W. Also, relay optical system may be provided to increase a distance from the cylindrical lens (converging optical system) 204 to the surface of the object W. Consequently, UV laser light or DUV laser light can be reduced in mutual coherence and directed as slit-like beam 205 (matching a shape of a light-receiving surface of a detector) onto the rough edges of the hyperfine circuit pattern on the object W from the oblique direction.

In this way, the edge roughness (rough edges) of the hyperfine circuit pattern are thus irradiated with the slit-like beam (linear beam) 205 by, as denoted by arrow 206, changing the irradiating direction of the plural slit-like beams with reduced spatial mutual coherence in a wide range, and converging the beams in the M-direction by the cylindrical lens 204. Therefore, smoothed reflection/diffraction patterns (except for zeroth-order components) enter an objective lens 3 from the edge roughness of the hyperfine circuit pattern on the object W and are converged on the objective lens. After this, the light is received by a linear sensor (linear image sensor) 6 and then smoothed image signals are detected from the rough edges. Of course, different sizes of foreign particles from hyperfine ones to fine ones are irradiated in substantially imaged form with a plurality of spatially incoherent slit-like beams whose irradiating direction has been changed in a wide range. Accordingly, reflected/diffracted light that covers a range from low-order components to high-order ones can be admitted from the above various foreign particles into the objective lens 3, and the image signals identifying various foreign particles from hyperfine ones to fine ones can be detected. In particular, to the edge roughness (rough edges) of the hyperfine circuit pattern on the object W, a large number of slit-like beams with reduced spatial coherence are directed from oblique directions in a converged condition and at multiple angles. Accordingly, reflected/scattered light from the edge roughness of ultra-microscopically random shapes is reduced in coherence, smoothed between chips, and detected by the linear sensor 6. Therefore, even if foreign particles or pattern defects present on the object (sample) W are to be detected from a data mismatch (differential image) based on chip comparisons, the edge roughness can be prevented from being incorrectly recognized as foreign particles or pattern defects. For logic sections, in particular, the image signals obtained from the edge roughness (rough edges) of the hyperfine circuit pattern are erased as a match based on chip comparisons. Therefore, the reflected/scattered light from the edge roughness is smoothed and matching based on chip comparisons can be established to make the comparisons valid.

Furthermore, since the circuit pattern is iterated for a memory section, the reflection/diffraction interference patterns generating from edges of the circuit patterns, including edge roughness, can be shielded by the spatial filter 4 installed on Fourier transform plane FTP.

As described above, the first example of irradiation optical system 1000 is totally constructed of light-transmitting media, and more particularly, constructed of a plate-like optical member group (light-transmitting medium group) 203a so as to enable formation of the plural slit-like beams reduced in coherence. The optical system can therefore be easily manufactured.

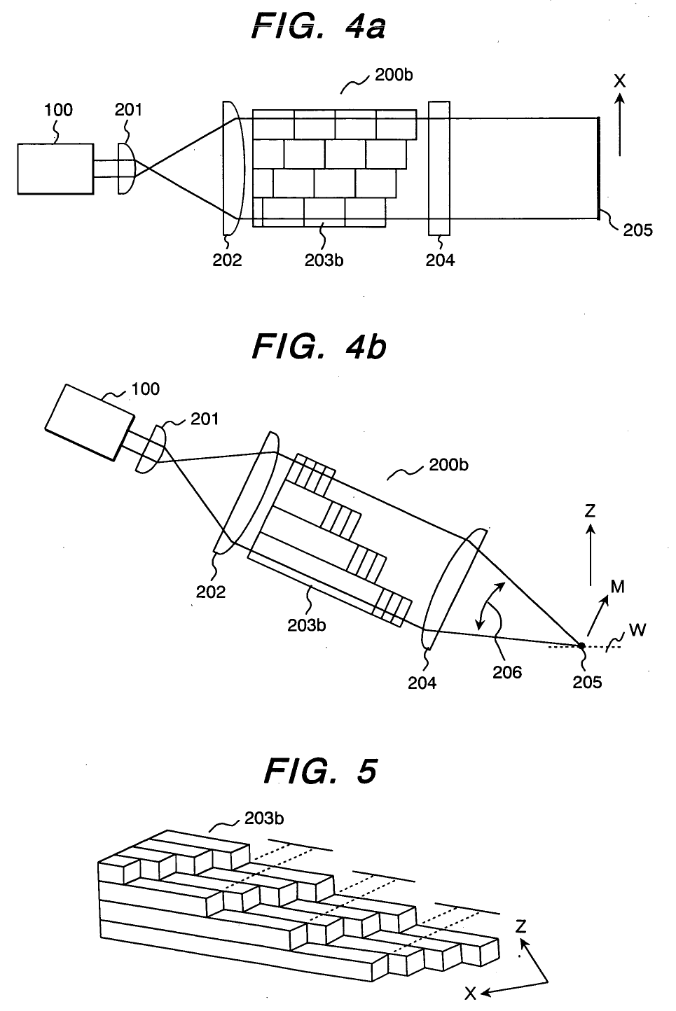

Next, a second example of irradiation optical system 1000 is described using FIGS. 4a, 4b, and 5. The second example of the irradiation optical system 1000 differs from its first example in a plate-like optical member group 203b (light-transmitting medium group) in an irradiation system 200b. This optical member group 203b is constructed not only to form parallel beams in an X-direction, but also to reduce each beam in coherence by changing an optical path length of the beam in the X-direction as shown in FIG. 5. Even if the beams, although basically almost parallel in the X-direction, are not completely parallel, the optical path length of each beam in the X-direction also is thus changed by the plate-like optical member group 203b by reducing coherence. Laser beams in both the X-direction and an M-direction, therefore, can be reduced in mutual coherence and then directed as a slit-like beam 205 (matching a shape of a light-receiving surface of a detector) onto edge roughness of a hyperfine circuit pattern on object W from an oblique direction (30° or less in horizontal angle “α”).

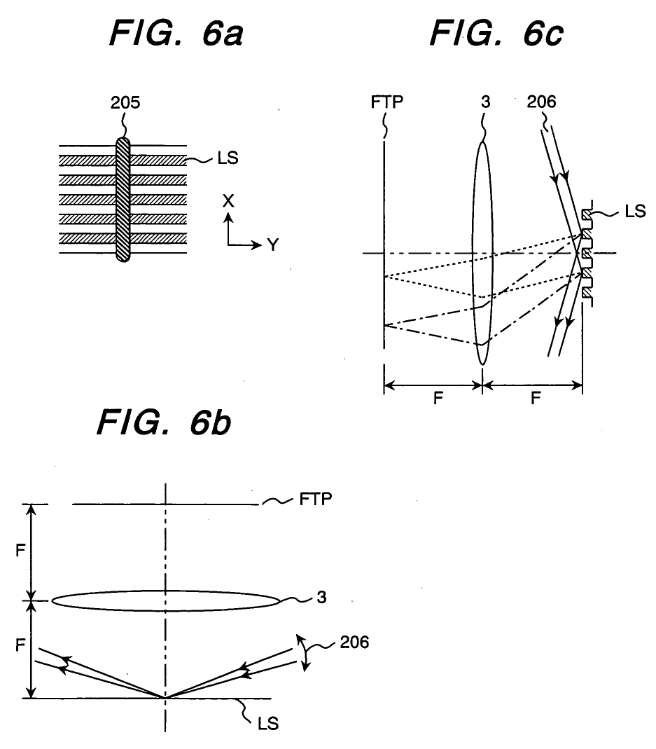

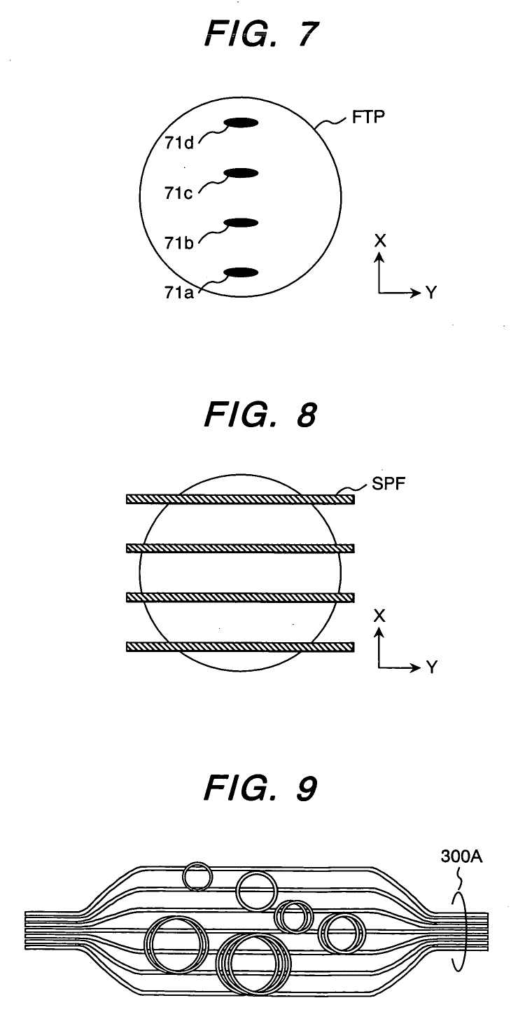

Next, a third example of irradiation optical system 1000 is described using FIGS. 6a-6c, 7, and 8. The third example is characterized by a manner in which a slit-like beam 205 is directed onto such an iterative pattern as seen in a memory section or the like. More specifically, for example, a rotary stage (not shown) is provided on a stage 17 having an object W rested thereon, and a rotational angle of the rotary stage is adjusted so that as shown in FIG. 6a, a longitudinal direction of the slit-like beam 205 is made substantially perpendicular to a direction of iterative pattern LS during irradiation. Consequently, as shown in FIG. 6b, even if laser light is converged in the direction denoted by arrow 206, high-order diffracted light from the iterative pattern does not occur at an optical axis of the converged light. Thus, detection of zeroth-order diffracted light (regular light reflections) can prevent by setting a numerical aperture (NA) of an objective lens 3 to a value of about 0.4 (or less) with which no zeroth-order diffracted light does not enter. At the same time, as shown in FIG. 7, pattern diffraction images 71a to 71d on Fourier transform plane FTP with a spatial filter 4 disposed thereon can be prevented from spreading in an X-direction. Thus, laser light can be shielded without extending any widths of the almost equally spaced linear spatial filters SPF shown in FIG. 8. Decreases in sensitivity due to spatial filtering can be prevented as a result.

Operation of the first embodiment is described next. First, the beam diameter of the coherent UV laser light or DUV laser light that has been emitted from the laser light source 100 is extended by the beam expander 201. Next, after the laser light has been converted into substantially parallel beams by the collimator lens 202, the parallel beams are passed through the easy-to-manufacture plate-like optical member group 203 constructed by stacking, at least in the M-direction, plate-like lenses different in optical path length from one another. As a result, slit-like beams with reduced coherence are output in the M-direction and directed from an oblique direction(s) through the cylindrical lens 204 onto the object W, in parallel beam form in the X-direction and in a converged condition in the M-direction. The thus-directed slit-like beam 205 (matching the shape of the light-receiving surface of the detector 6) is radiated substantially with image formation onto the surface of the object W.

In this way, in the M-direction, the plural slit-like beams with reduced coherence that were emitted from the plate-like optical member group 203 are converged into the slit-like beam 205 by being changed the incident angles in the wide range, and this beam is directed from an oblique direction (with inclination angle “α”) onto the surface of the object W. In other words, the beams from the plate-like optical member group 203 are converged, in the X-direction, from oblique directions so as to be substantially parallel, and in the M-direction, in a spread state of the incident angle range of the beams. The slit-like beam 205 of spatially incoherent UV or DUV laser light that has coherence reduced at least in the M-direction is thus applied.

As a result, regular light reflections from the object W do not enter the pupil of the objective lens 3 (when the objective lens has an NA value of about 0.4 or less). Also, smoothed reflection/diffraction patterns (except for zeroth-order components) from the edge roughness of the hyperfine circuit pattern on the object W enter the objective lens 3 and are converged thereon. This reduces a differential image (data mismatch) based on chip comparisons, and makes it possible to prevent foreign particles and pattern defects from being incorrectly identified. In addition, reflection/diffraction interference patterns from such iterative circuit patterns as seen in the memory section or the like can be shielded using the spatial filter 4 installed on Fourier transform plane FTP.

Furthermore, light may be reflected/scattered from the foreign particles present on the hyperfine circuit pattern of the object W that range from hyperfine foreign particles as small as on the order of up to several tens of nanometers, to fine foreign particles (i.e., reflected/diffracted light with first-order to higher-order components). The light is admitted into and converged on the objective lens 3, then passed through the spatial filter 4, and received by the detector 6 such as a TDI sensor, through the tube lens (image-forming lens) 5. Image signals that identify the foreign particles ranging from hyperfine ones to fine ones are thus detected. More specifically, the light scattered from the foreign particles is detected while the X-Y-Z stage 17 is being moved in a horizontal direction with the object W mounted on the stage, and detection results are acquired as two-dimensional image signals.

As described above, even if the slit-like beam 205 being radiated on the object W is laser light whose coherence has been reduced, the beam 205 is temporal (time-wise) coherent, i.e., maintains monochromaticity. This provides the following advantage. That is, the objective lens 3 and the tube lens 5 have their design and manufacture simplified since the kinds of color corrections conducted during the design and manufacture of both lenses can be limited to monochromatic correction only of the particular laser wavelength. There is also another advantage. That is, when the pattern formed on the object W is such iterative pattern as seen in the memory section, laser light can be easily shielded by spatial filtering. This is because a reflection/diffraction interference patterns from the iterative circuit patterns occur discretely for a single wavelength as shown in FIG. 7, and because the interference patterns are discretely converged on Fourier transform plane FTP.

Image signals that have thus been acquired are converted into digital image signals by the A/D converter 20. After passing through the delay circuit 21 that delays the digital image signals according to the particular pitch of the chips or cells, the digital image signals are stored as reference image signals into the image memory 22. Next, digital image signals that have been detected by adjacent chips or cells are stored as detected image signals into the image memory 23. After this, the comparison and arithmetic processing unit 24 first compares the reference image data with detected image data of the same chip regions or the same cell regions that have been stored in the image memories 22 and 23, respectively. Next, the processing unit 24 extracts differential image data (differences), compares the differential image data (mismatch values) with judgment thresholds, and identifies foreign particles or pattern defects. Finally, the processing unit 24 outputs position coordinates, characteristic values (such as an area and a size/dimensions), defect images, and other factors of the foreign particles or defects, to the main control unit 11.

The main control unit 11 sends the above judgment/identification results, namely, the position coordinates, characteristic values (such as an area and a size/dimensions), defect images, and other factors of the foreign particles or defects, to the display 12 or saves the results in the storage device 14. Also, the arithmetic device 13 identifies sizes, locations, and other information on the foreign particles or defects.

As set forth above, according to the first embodiment, since the entire irradiation optical system 1000, except for the laser light source 100, is constituted by lenses and plate-like light-transmitting media, the optical system 1000 can be manufactured easily at a low cost.

### Second Embodiment

Next, a second embodiment of the present invention will be described using FIGS. 9 to 23a, 23b. The second embodiment differs from the first embodiment in that an irradiation system 200b in irradiation optical system 1000 uses a single-mode fiber bundle (single-mode fiber group) 300A whose optical path length is changed to reduce coherence.

FIG. 9 shows single-mode fiber bundle 300A which, when a high-coherence laser light source is used as a light source 100 to emit UV laser light or DUV laser light, maintains temporal (time-wise) coherence intact and reduces only spatial coherence. That is to say, single-mode fibers 300a of the single-mode fiber bundle 300A are each provided with an optical path length difference greater than a laser coherence length, and exit beams from the single-mode fibers 300a become mutually incoherent beams. Therefore, low-coherence light illumination using the laser that is the coherent light source becomes possible by irradiating an object W using an exit end face of the single-mode fiber bundle 300A as a secondary light source.

Even such low-coherence laser light is temporal coherent, that is to say, the laser light maintains monochromaticity. This provides the advantage that an objective lens 3 and a tube lens 5 have their design and manufacture simplified since the kinds of color corrections conducted during the design and manufacture of both lenses can be limited to monochromatic correction only of the particular laser wavelength. There is also another advantage. That is, when the pattern formed on the object W is such an iterative pattern as seen in a memory section, laser light can be easily shielded by spatial filtering. This is because a reflection/diffraction interference patterns from the iterative circuit patterns occur discretely for a single wavelength as shown in FIG. 7, and because the interference patterns are discretely converged on Fourier transform plane FTP.

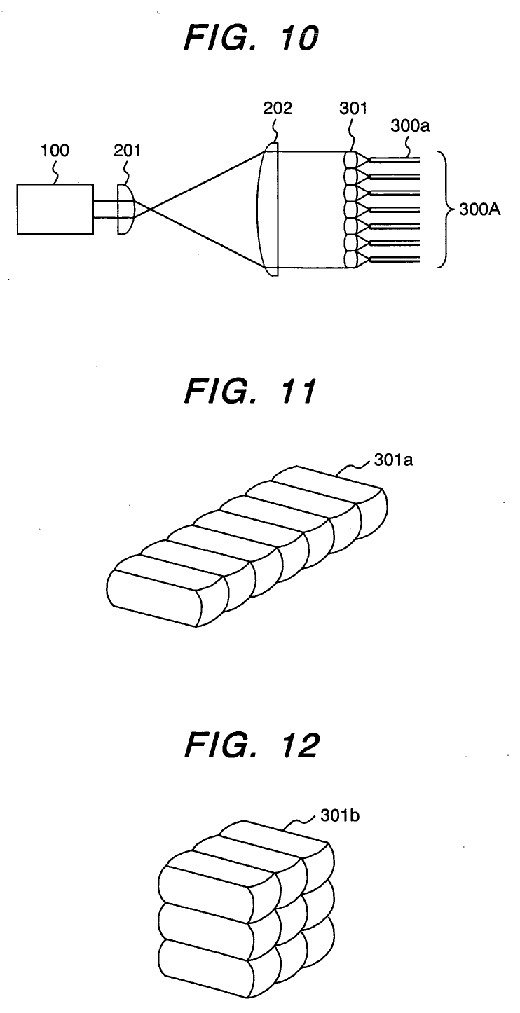

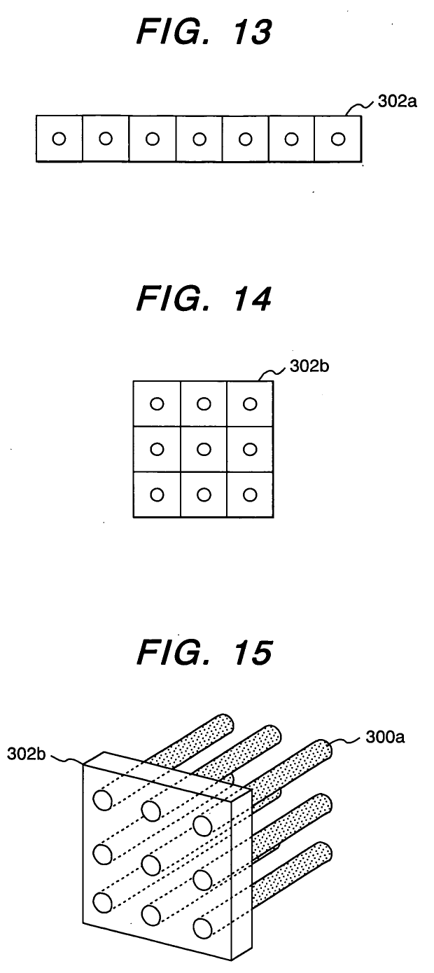

Next, the irradiation system provided on the incident side of the light admitted into the single-mode fiber bundle 300A will be described using FIGS. 10 to 15. As shown in FIG. 10, the laser beams that have been emitted from the laser light source 100 are extended in beam diameter by a beam expander 201 and then converted into substantially parallel beams by a collimator lens 202. If, as shown in FIG. 13, single-mode fibers of the single-mode fiber bundle 300A on the incident side are arranged in line by use of a holder 302a, the above-converted parallel light is split into beams by being admitted into each converging lens of such a converging lens group (converging lens array) 301a as shown in FIG. 11. Thus, the parallel beams of light that have been obtained by splitting can be efficiently coupled by being admitted in a converged condition from each converging lens into an incident end of each single-mode fiber 300a. In this case, the beam expander 201 needs only to extend the beam diameter only in an arrangement direction of the single-mode fibers 300a.

As shown in FIGS. 14 and 15, the single-mode fibers of the single-mode fiber bundle 300A on the incident side may be arranged two-dimensionally by use of the holder 302a. In this case, parallel light that has been converted by the above collimator lens 202 is split into beams by being admitted into each two-dimensionally arranged converging lens of such a converging lens group (converging lens array) 301b as shown in FIG. 12. Thus, the parallel beams of light that have been obtained by splitting can be efficiently coupled by being admitted in a converged condition from each converging lens into the incident end of each single-mode fiber 300a. In this case, the beam expander 201 is to extend the beam diameter two-dimensionally.

That is, the above can be achieved by creating a plurality of beam-converging points with use of the fly's-eye lens 301a, 301b that is entirely formed of a lens, and arranging each single-mode fiber 300a of the single-mode fiber bundle 300A at each of the converging points. Depending on particular needs, the fly's-eye lens may be constructed into a one-dimensional array form as shown in FIG. 11, or a two-dimensional array form as shown in FIG. 12. In accordance with the particular array form, each single-mode fiber 300a of the single-mode fiber bundle 300A may also be arranged into a one-dimensional array form as shown in FIG. 13, or a two-dimensional array form as shown in FIG. 14 (FIG. 15). In the present embodiment, although a fly's-eye lens is used as the array-form lens, a lens array such as a microlens array can be used instead. In addition, although the single-mode fiber bundle 300A shown in each figure is constituted by seven fibers, it is obvious that the number of single-mode fibers is not limited to seven.

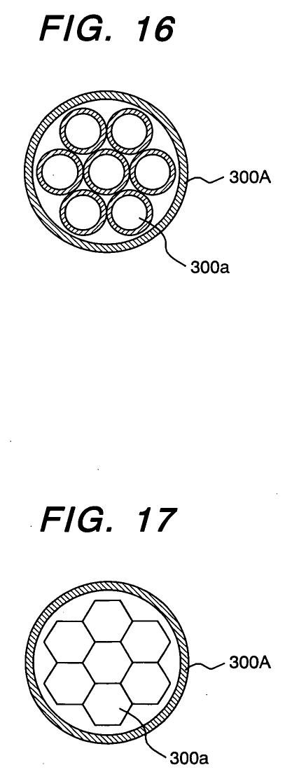

If there is a sufficient margin on the quantity of light and high coupling efficiency is not required, exit beams from the laser light source 100 may be extended in beam diameter by the beam expander formed up of the lenses 201 and 202, and then the parallel beams may be admitted into the single-mode fiber bundle 300A as they are. If the single-mode fibers used at this time are the fibers that were bundled in the format shown in FIG. 16, a coupling loss of the fibers can be reduced because of their enhanced space occupancy ratio. Additionally, forming the single-mode fibers into a hexagonal honeycomb-structured shape as shown in FIG. 17 allows a space occupancy ratio of the fibers to be further improved for reduced coupling loss.

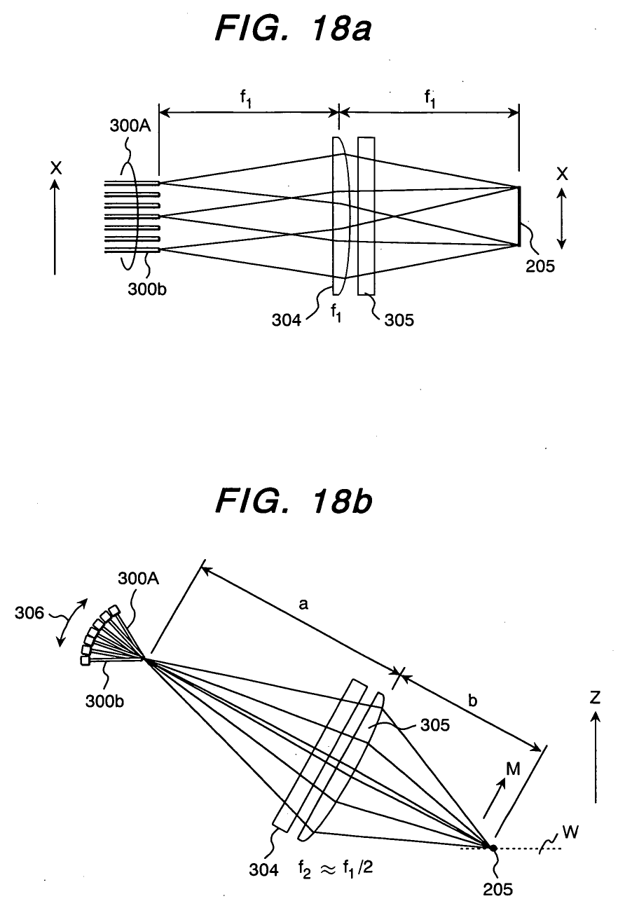

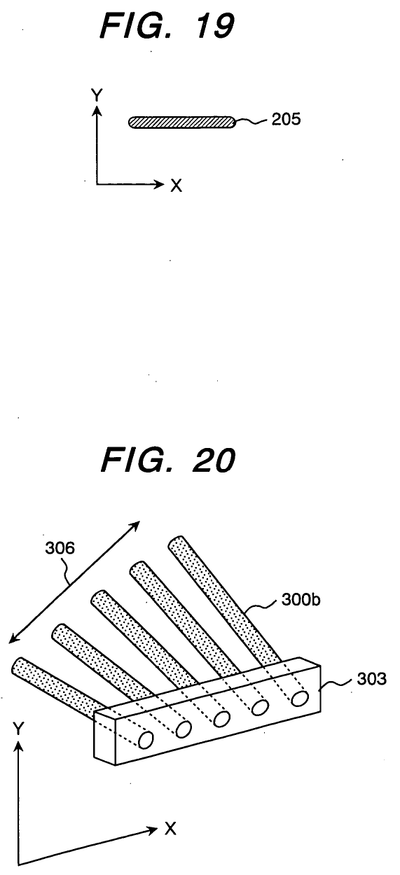

Next, a first example of the irradiation system provided at the exit side of the light emitted from the single-mode fiber bundle 300A will be described using FIGS. 18a, 18b, to 20. A slit-like beam 205 that was converged in an M-direction as shown in FIG. 19 needs to be directed from an oblique direction onto the surface of an object W. It is necessary, therefore, that as shown in FIG. 18b and as denoted by arrow 306 in FIG. 20, each single-mode fiber 300a needs to be held by means of a holder 303 with an exit angle difference given at the exit end of the single-mode fiber bundle 300A that operates as a secondary light source unit.

Consequently, in the X-direction, mutually incoherent (spatially incoherent) beams that have been emitted from exit ends (secondary spot light sources) of the single-mode fibers 300a in the single-mode fiber bundle 300A are converged into and applied as a slit-like beam 205 with its longitudinal direction (X-direction) determined by a cylindrical lens 304 having focal length “f1”, and with substantially even illuminance in the X-direction.

For the M-direction, the spatially incoherent beams are emitted from the exit ends (secondary spot light sources) of the single-mode fibers 300a in the single-mode fiber bundle 300A at exit angles slightly different from one another and with reduced mutual coherence. In addition, as shown in FIG. 18b, they are converged in the M-direction and applied as slit-like beam 205 in a substantially image-forming condition by cylindrical lens (converging optical system) 305 whose focal length “f2” is almost equal to f1/2. This means that in terms of principles, the exit light from each single-mode fiber 300a becomes the diffused light that spreads with the same NA value as that of the incident beams before they were converged.

For the above reasons, first, the cylindrical lens 304 with focal length “f1” is disposed at a location distant by “f1” from the single-mode fibers 300a. Thus, in the X-direction, the laser light becomes parallel beams (Koehler illumination), and in the M-direction, the laser light remains diffused light. Next, at immediate rear of the cylindrical lens 304, the cylindrical lens (converging optics) 305 is disposed with its convex surface and its flat surface orthogonal to the cylindrical lens 304. Thus, the laser light becomes parallel beams in the X-direction and diffused light in the M-direction, and converged spot light becomes a linear (slit-like) beam 205. When the distance from the single-mode fibers 300a is taken as “a”, the focal length of the cylindrical lens 305, as “f2”, and a distance from the cylindrical lens 305 to converging point 205, as “b”, it is preferable that “a” be almost equal to “f1”, “b” be also almost equal to “f1”, and “f2” be almost equal to “f1/2”.

As described above, in the M-direction, spatially incoherent beams with reduced mutual coherence are emitted from the exit end of the single-mode fiber bundle 300A at different exit angles. The beams are also converged at different angles when converged and emitted as slit-like beam 205. Accordingly, similarly to the first embodiment, smoothed reflection/diffraction patterns (except for zeroth-order components) enter an objective lens 3 from edge roughness (rough edges) of the hyperfine circuit pattern formed on the object W and are converged on the objective lens. After this, the light is received by a linear sensor (linear image sensor) 6 and then smoothed image signals are detected from the edge roughness. Of course, different sizes of foreign particles from hyperfine ones to fine ones are irradiated in substantially imaged form with a plurality of spatially incoherent slit-like beams whose irradiating direction has been changed in a wide range. Accordingly, reflected/diffracted light that covers a range from low-order components to high-order ones can be admitted from the above various foreign particles into the objective lens 3, and the image signals identifying various foreign particles from hyperfine ones to fine ones can be detected.

Signals associated with the light that has been received by the linear sensor 6 can be detected. In other words, for the edge roughness (rough edges) of the hyperfine circuit pattern on the object W, a large number of slit-like beams with reduced spatial coherence are directed from oblique directions in a converged condition and at multiple angles. Accordingly, reflected/scattered light from the edge roughness of ultramicroscopically random shapes is reduced in coherence, smoothed between chips, and detected by the linear sensor 6. Therefore, even if foreign particles or pattern defects present on the object W are to be detected from a data mismatch (differential image) based on chip comparisons, the edge roughness can be prevented from being incorrectly recognized as foreign particles or pattern defects. For logic sections, in particular, since the image signals obtained from the edge roughness of the hyperfine circuit pattern are erased as a match based on chip comparisons, the reflected/scattered light from the edge roughness is smoothed and matching based on chip comparisons can be established to make the comparisons valid.

Furthermore, since the circuit pattern is iterated for the memory section, the reflection/diffraction interference patterns generating from edges of the circuit pattern, including edge roughness, can be shielded by the spatial filter 4 installed on the Fourier transform plane FTP.

Consequently, similarly to the first embodiment, the light reflected/scattered from the foreign particles present on the hyperfine circuit pattern of the object W that are hyperfine foreign particles as small as on the order of up to several tens of nanometers is admitted into and converged on the objective lens 3. Then, it passed through the spatial filter 4, and received by the detector 6 such as a TDI sensor, through the tube lens (image-forming lens) 5. Image signals that identify the hyper fine foreign particles are thus detected. This allows a comparison and arithmetic processing unit 24 first to compare the reference image data with detected image data of the same chip or cell region that have been stored within image memories 22 and 23, respectively. Next, the processing unit 24 can extract differential image data (differences), compare the differential image data (mismatch values) with judgment thresholds, and identify foreign particles or pattern defects. Finally, the processing unit 24 can output position coordinates, characteristic values (such as an area and a size/dimensions), defect images, and other factors of the foreign particles or defects, to a main control unit 11.

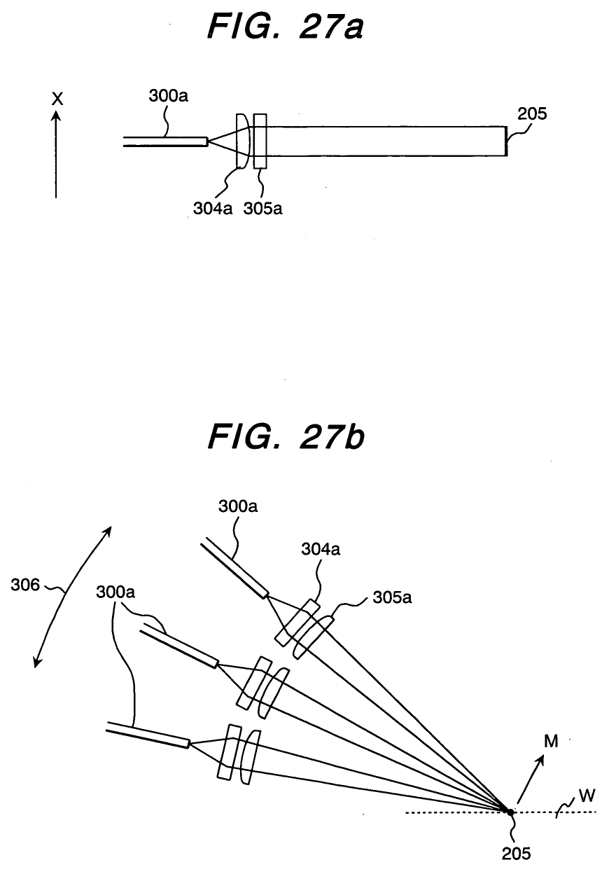

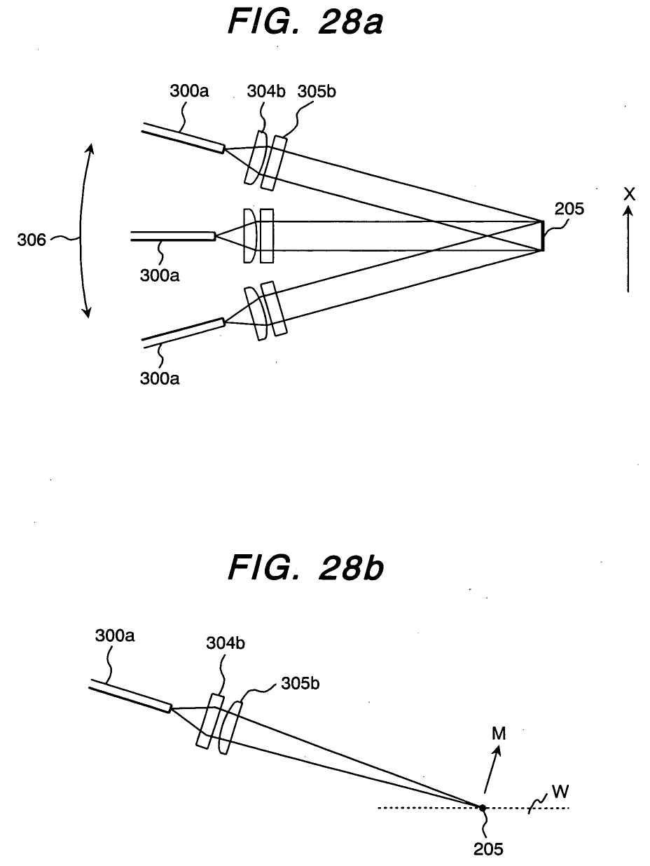

Next, second and third examples of the irradiation system provided on the exit side of the light emitted from the single-mode fiber bundle 300A will be described using FIGS. 27a, 27b, and 28a, 28b. A slit-like beam 205 that was converged in an M-direction needs to be directed from a plurality of oblique directions onto the surface of an object W. In the second example of FIGS. 27a, 27b, therefore, it is necessary that as shown with arrow 306 in FIG. 27b, each single-mode fiber 300a be held by means of a holder (not shown) with an exit angle difference given at the exit end of the single-mode fiber bundle (group) 300A that operates as a secondary light source.

Consequently, in an X-direction, each of mutually incoherent (spatially incoherent) beams that have been emitted from exit ends (secondary spot light sources) of the single-mode fibers 300a in the single-mode fiber bundle 300A is converted into each of parallel beams by each of cylindrical lenses 305a, as shown in FIGS. 27a and 27b. Then, they are converged into and applied as a slit-like beam 205 with its longitudinal direction (X-direction) determined by each of cylindrical lenses 305a, and with substantially even illuminance in the X-direction.

In the third example of FIGS. 28a and 28b, therefore, it is necessary that as shown with arrow 306 in FIG. 28a, each single-mode fiber 300a be held by means of a holder (not shown) with an exit angle difference given at the exit end of the single-mode fiber bundle (group) 300A that operates as a secondary light source.

Consequently, each of mutually incoherent (spatially incoherent) beams emitted from the exit ends (secondary spot light sources) of the single-mode fibers 300a in the single-mode fiber bundle (group) 300A is converted into each of parallel beams by each of cylindrical lenses 305b. Then, they are converged into and irradiated as a slit-like beam 205 with its longitudinal direction (X-direction) determined by each of cylindrical lenses 305b, and with substantially even illuminance in the X-direction.

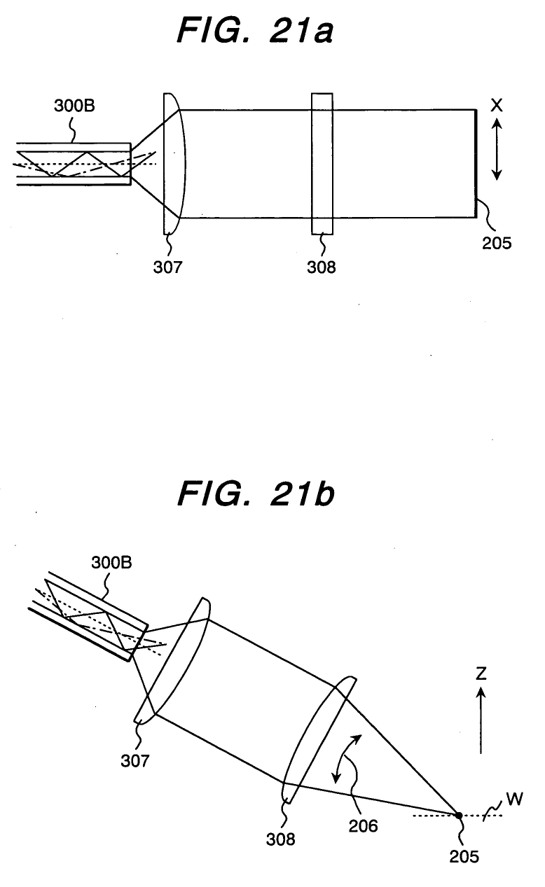

Next, examples of using a multi-mode fiber bundle 300B instead of the single-mode fiber bundle 300A are described using FIGS. 21a, 21b to 25a, 25b. Laser beams that have entered the multi-mode fiber bundle 300B can be emitted therefrom without interfering with one another. Parallel beams can be admitted into the multi-mode fiber bundle 300B intact after being extended in beam diameter by a beam expander formed up of lenses 201 and 202.

In the first example of the exit side of the multi-mode fiber bundle 300B, as shown in FIGS. 21a and 21b, incoherent laser light that has been emitted from an exit end of the multi-mode fiber bundle 300B is converted into parallel beams by a collimator lens 307. Then the surface of an object W is irradiated obliquely with the parallel beams almost maintaining their parallelism in the X-direction and converged in the M-direction.

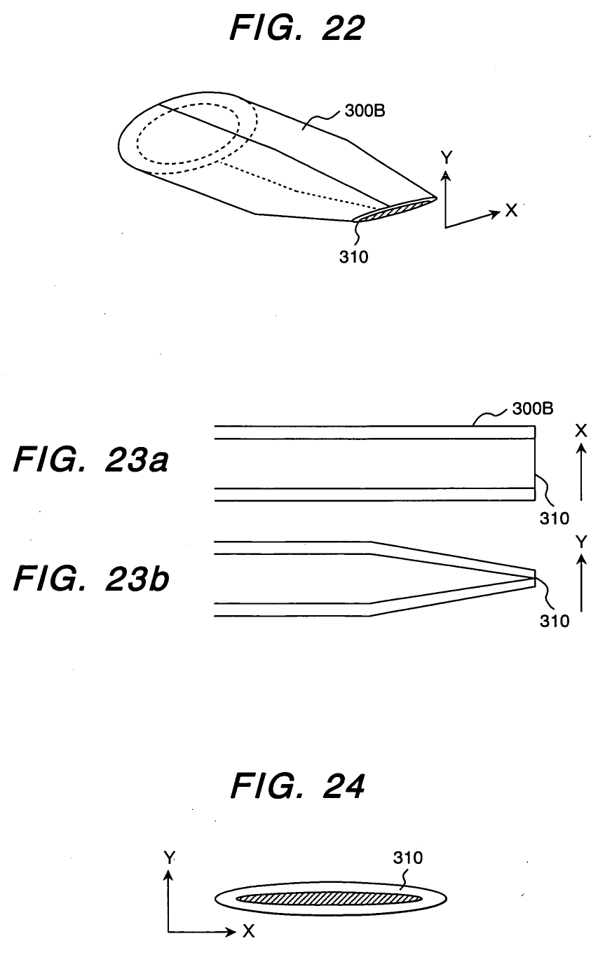

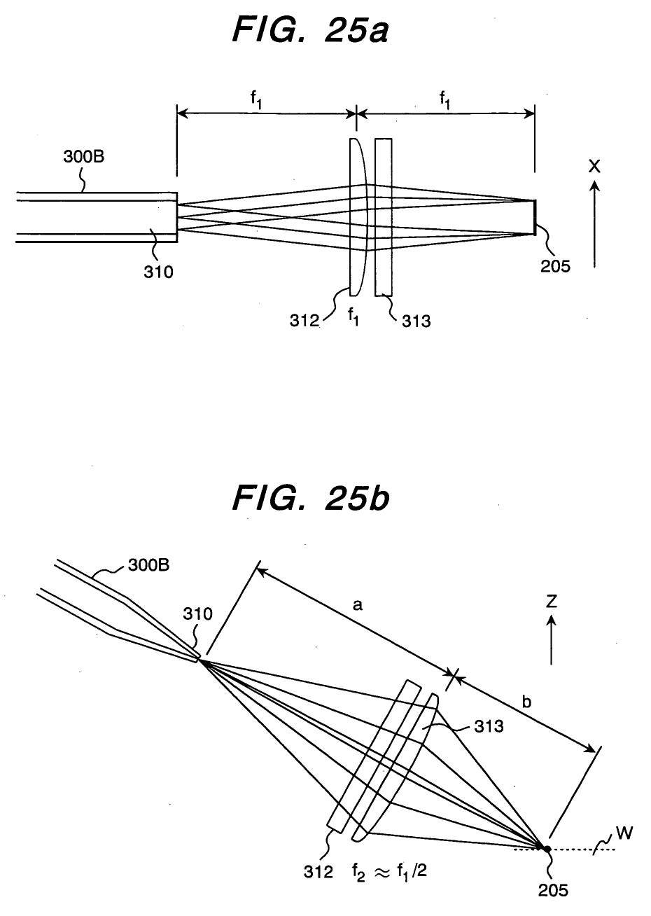

The second example of the exit side of the multi-mode fiber bundle 300B is characterized in that as shown in FIGS. 22, 23a, 23b, and 24, an exit end 310 of the multi-mode fiber bundle 300B is brought close to a slit-like beam 205 with a shape of the exit end narrowed down in a Y-direction. FIG. 22 is a perspective view showing the exit end 310 of the multi-mode fiber bundle 300B, FIGS. 23a, 23b are plan and front views, respectively, of the exit end, and FIG. 24 is a diagram showing the shape thereof. As a result, it is possible, by using cylindrical lens 312 and another cylindrical lens (beam-converging optics) 313, to converge incoherent laser beams whose angles of incidence have been changed in a wide range, and irradiate the surface of the object W from an oblique direction with the converged light as a slit-like beam 205 in a substantially image-forming state as shown in FIGS. 25a, 25b.

As described above, even when the multi-mode fiber bundle 300B is used, it is possible, as with use of the multi-mode fiber bundle 300A, to apply UV or DUV laser light from an oblique direction as a slit-like beam 205 in a substantially image-forming state.

As set forth above, according to the second embodiment, there is also a need to use a special fiber bundle.

The invention may be embodied in other specific forms without departing from the spirit or essential characteristics thereof. The present embodiment is therefore to be considered in all respects as illustrative and not restricted, the scope of the invention being indicated by the appended claims, rather than by the foregoing description, and all changes that come within the meaning and range of equivalency of the claims are therefore intended to be embraced therein.

1. An apparatus for defecting defects, said apparatus comprising:
an irradiation optical system which has a laser light source and an irradiation section which reduces coherence of coherent laser light emitted from said laser light source, and then irradiates laser light reduced in coherence in a converged state as a slit-like beam from an oblique direction onto a surface of a substrate to be subjected to defect inspection;
a detection optical system which detects reflection/diffraction light from the surface of the substrate irradiated by said irradiation section of said irradiation optical system;
a linear sensor which outputs corresponding image signals by receiving the reflection/diffraction light detected by said detection optical system; and
a comparison processing unit which identifies defects or defect candidates, inclusive of foreign particles, that exist on the substrate being subjected to defect inspection, by comparing with the image signals obtained from same chip regions or same cell regions and then outputted from said linear sensor;
wherein said irradiation section of said irradiation optical system includes:
an optical member group formed by stacking a plurality of plate-like optical members that receive the coherent laser beam emitted from said laser light source, and emit a plurality of slit-like beams each of which has been spatially reduced in coherence at least in a beam-converging direction, the plurality of plate-like optical members being different from one another in optical path length at least in the beam-converging direction; and
a beam-converging optical system which converges the plurality of slit-like beams each emitted with spatially reduced coherence from said optical member group, into a slit-like beam in the beam-converging direction and irradiates the slit-like beam from the oblique direction onto the surface of the substrate being subjected to defect detection.

2. The defect detection apparatus according to claim 1, wherein said irradiation section further has a beam expander for extending a beam diameter of the coherent laser beam emitted from said laser light source, and admit into said optical member group the laser beam whose beam diameter has been extended by said beam expander.

3. The defect detection apparatus according to claim 1, wherein said laser light source emits UV or DUV laser light.

4. The defect detection apparatus according to claim 1, wherein said beam-converging optical system irradiates the slit-like beam from a plurality of angle directions onto the surface of the substrate.

5. The defect detection apparatus according to claim 1, wherein said optical member group is constructed so that said optical members are different from one another in optical path length further in a longitudinal direction of the slit-like beams to get spatially incoherent with respect to one another.

6. The defect detection apparatus according to claim 1, wherein said detection optical system further has a spatial filter which shields reflection/diffraction interference patterns generating from iterative patterns formed on the substrate being subjected to defect detection.

7. The defect detection apparatus according to claim 6, wherein said detection optical system further has a Fourier transform lens group formed into a bilateral telecentric form.

8. The defect detection apparatus according to claim 1, wherein said linear sensor is a TDI sensor.

9. An apparatus for defecting defects, said apparatus comprising:
an irradiation optical system which has a laser light source and an irradiation section which reduces coherence of coherent laser light emitted from said laser light source, and then irradiates laser light reduced in coherence in a converged state as a slit-like beam from an oblique direction onto a surface of a substrate to be subjected to defect inspection;
a detection optical system which detects reflection/diffraction light from the surface of the substrate irradiated by said irradiation section of said irradiation optical system;
a linear sensor which outputs corresponding image signals by receiving the reflection/diffraction light detected by said detection optical system; and
a comparison processing unit which identifies defects or defect candidates, inclusive of foreign particles, that exist on the substrate being subjected to defect inspection, by comparing with the image signals obtained from same chip regions or the same cell regions and then outputted from said linear sensor;
wherein said irradiation section of said irradiation optical system includes:
a single-mode fiber group formed up of a plurality of single-mode fibers that receive the coherent laser beam emitted from said laser light source, and emit a plurality of beams each of which has been spatially reduced in coherence at least in a beam-converging direction, the plurality of single-mode fibers being different from one another in optical path length at least in the beam-converging direction; and
a beam-converging optical system which converges a plurality of beams each emitted with spatially reduced coherence from said single-mode fibers, into a slit-like beam in the beam-converging direction and irradiates as the slit-like beam from the oblique direction onto the surface of the substrate being subjected to defect detection.

10. An apparatus for defecting defects, said apparatus comprising:
an irradiation optical system which has a laser light source and an irradiation section which reduces coherence of coherent laser light emitted from said laser light source, and then irradiates laser light reduced in coherence in a converged state as a slit-like beam from an oblique direction onto a surface of a substrate to be subjected to defect inspection;
a detection optical system which detects reflection/diffraction light from the surface of the substrate irradiated by said irradiation section of said irradiation optical system;
a linear sensor which outputs corresponding image signals by receiving the reflection/diffraction light detected by said detection optical system; and
a comparison processing unit which identifies the defects or defect candidates, inclusive of foreign particles, that exist on the substrate being subjected to defect inspection, by comparing with the image signals obtained from same chip regions or same cell regions and then outputted from said linear sensor;
wherein said irradiation section of said irradiation optical system includes:
multi-mode fibers each of which spatially reduces coherence of the coherent laser beam emitted from said laser light source, and then emits beams with spatially reduced coherence; and
a beam-converging optical system which converges the beams emitted with spatially reduced coherence from said multi-mode fibers, into a slit-like beam in the beam-converging direction and irradiates as the slit-like beam from the oblique direction onto the surface of the substrate being subjected to defect detection.

11. A method for detecting defects, said method comprising:
an irradiation step for, after reducing coherence of coherent laser light emitted from a laser light source, irradiating laser light reduced in coherent in a converged state as a slit-like beam from an oblique direction onto a surface of a substrate to be subjected to defect inspection, by a irradiation optical system;
a detection step for detecting reflection/diffraction light from the surface of the substrate irradiated by said irradiation step, by a detection optical system and for outputting corresponding image signals by receiving the reflection/diffraction light detected by said detection optical system, by means of a linear sensor; and
a comparative processing step for identifying defects or defect candidates, inclusive of foreign particles, that exist on the substrate being subjected to defect inspection, by comparing with the image signals obtained from same chip regions or same cell regions and then outputted by said detection step;
wherein said irradiation step further includes:
a coherence reduction step for first admitting the coherent laser beam emitted from the laser light source, into an optical member group formed by stacking a plurality of plate-like optical members different from one another in optical path length at least in a converging direction of the beam, and then emitting a plurality of slit-like beams each of which has been spatially reduced in coherence at least in the beam-converging direction; and
a beam-converging step for converging the plurality of emitted slit-like beams into a slit-like beam in the beam-converging direction and irradiating the slit-like beam from the oblique direction onto the surface of the substrate being subjected to defect detection.

12. The method for detecting defects according to claim 11, wherein said irradiation step includes a beam diameter-extending step for extending via a beam expander a beam diameter of the coherent laser beam emitted from the laser light source, and admitting the laser beam of the extended beam diameter into the optical member group.

13. The method for detecting defects according to claim 11, wherein the coherent laser beam emitted from the laser light source in said irradiation step is UV or DUV laser light.

14. The method for detecting defects according to claim 11, wherein the slit-like beam in said beam-converging step is irradiated from a plurality of angle directions with respect to the beam-converging direction onto the surface of the substrate.

15. The method for detecting defects according to claim 11, wherein said detection step further includes a beam-shielding step for shielding, via a spatial filter provided in the detection optical system, reflection/diffraction interference patterns generating from iterative patterns formed on the substrate being subjected to defect detection.
